(19) United States
(12) Patent Application Publication
(10) Pub. No.: US 2022/0143901 A1
(43) Pub. Date: May 12, 2022

(54) 3D PRINTED OPTICS

(71) Applicant: SIGNIFY HOLDING B.V., EINDHOVEN (NL)

(72) Inventors: RIFAT ATA MUSTAFA HIKMET, EINDHOVEN (NL); JOHANNES PETRUS MARIA ANSEMS, HULSEL (NL); BERT WOUTERS, VELDHOVEN (NL); PAULUS ALBERTUS VAN HAL, WAALRE (NL)

(21) Appl. No.: 17/433,855

(22) PCT Filed: Mar. 2, 2020
(86) PCT No.: PCT/EP2020/055403

§ 371 Date: Aug. 25, 2021

(30) Foreign Application Priority Data
Mar. 11, 2019 (EP) 19161810.7

(51) Int. Cl. B29C 64/118

(52) U.S. Cl. CPC B29C 64/118; B29L 2011/0075

(57) ABSTRACT

The invention provides a method for manufacturing a 3D item (1) by means of fused deposition modelling, wherein the 3D item (1) is a multi-arm light guide having an articulated body of at least two connected body elements (310), wherein each body element (310) is an arm of the multi-arm light guide, wherein each body element (310) has a first end (311) and a second end (312), wherein the first ends (311) of the connected body elements (310) are for incoupling of light in the multi-arm light guide, wherein the second ends (312) of the connected body elements (310) diverge from each other and are for outcoupling of light from the multi-arm light guide, wherein the method comprises a 3D printing stage wherein an extrudate (321) comprising a 3D printable material (201) is deposited in a layer-wise manner to provide the 3D item (1) comprising a 3D printed material (202); wherein the 3D printable material (201) comprises a light transmissive material; wherein the 3D item (1) comprises one or more layers (322) of the 3D printed material (202), wherein each of the connected body elements (310) comprises at least two adjacent 3D printed layer parts (1322); wherein the method comprises:—for each of the body elements (310) printing a single continuous layer part (2322) comprising the at least two adjacent 3D printed layer parts (1322), wherein the printing of the single continuous layer part (2322) involves printing in a first direction and then turning back and printing back in a second direction opposite to the first direction to provide a first body element U-turn (313) at the first end (311) of the body element (310); and—connecting adjacent body elements (310) by one or more of (i) merging parts of the adjacent body elements (310), (ii) 3D printing a connection element (320) connecting the adjacent body elements (310), and (iii) 3D printing the single continuous layer part (2322) comprising the 3D printed layer parts (1322) of the adjacent body elements (310).

### FIELD OF THE INVENTION

The invention relates to a method for manufacturing a 3D (printed) item by means of fused deposition modelling, and to a software product for executing such method. The invention also relates to the 3D (printed) item obtainable with such method. Further, the invention relates to a lighting device including such 3D (printed) item.

### BACKGROUND OF THE INVENTION

Lenses with articulated elements are known in the art. WO2017/118565, for instance, describes a lens which is an integrated single piece, comprising an inner arch and an outer arch, the inner arch and outer arch having a shared elongate central region and each having opposing walls extending from opposite elongate ends of the shared elongate central region, wherein the walls of the inner arch are spatially separated from the walls of the outer arch.

### SUMMARY OF THE INVENTION

A multi-arm light guide is an optical element having an articulated body of at least two connected body elements. Each body element is an arm of the multi-arm light guide. Each body element has a first end and a second end. The first ends of the connected body elements are for incoupling of light in the multi-arm light guide. The second ends of the connected body elements diverge from each other and are for outcoupling of light from the multi-arm light guide.

Multi-arm light guides may be difficult to make and/or may not be easily made with customized shapes.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

Herein, it is proposed to use 3D printing to provide such multi-arm type light guides.

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals and polymers. 3D printing can also be used in producing molds which can then be used for replicating objects.

For the purpose of making molds, the use of polyjet technique has been suggested. This technique makes use of layer by layer deposition of photo-polymerisable material which is cured after each deposition to form a solid structure. While this technique produces smooth surfaces the photo curable materials are not very stable and they also have relatively low thermal conductivity to be useful for injection molding applications.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

Surprisingly, it appears, however, that specific 3D (FDM) printing strategies have to be chosen to create 3D printed items that are suitable as optical component, such as a multi-arm type light guides.

Amongst others, herein e.g. multi arm distributed wave guides to obtain any desired beam shape in the far field using fused deposition modelling to create such wave guides are suggested. When thin nozzles are used very detailed printing of objects can be produced with high dimensional accuracy. However, using a small nozzle increases the printing time substantially. For that reason, spiralized printing strategy, where the printer follows continuously a path, may be used. However, as a result of this strategy artifacts, such as flat surfaces becoming curved, may take place changing the performance of the optical function may occur. Herein, amongst others various printing strategies for printing such a wave guided beam shaping optics for obtaining the desired optical effect are described. Best results were obtained when the wave guide plate entrance had a single curve (“U-curve”) and the exit surface was as flat as possible. Further, the presence of the ribbed structure also appears to assist in spreading the beam and removing a possible spotty appearance. In a configuration, the wave guide elements get connected to each other forming a self-supporting luminaire where the surfaces of the wave guide is protected against dust and other dirt. Furthermore, the present invention makes it possible to combine different wave plate configurations in such a luminaire in order to produce different light distributions from different parts of the luminaire. Multiple wave guides can be placed above a light source for coupling light into these light guides. The orientation of the end of the wave guides can then be aligned in a desired manner to obtain the desired light distribution.

Hence, in a first aspect the invention provides a method for producing a 3D item (“item” or “3D printed item”) by means of fused deposition modelling. The 3D item is a multi-arm light guide having an articulated body of at least two connected body elements, wherein each body element is an arm of the multi-arm light guide, wherein each body element has a first end and a second end, wherein the first ends of the connected body elements are for incoupling of light in the multi-arm light guide, wherein the second ends of the connected body elements diverge from each other and are for outcoupling of light from the multi-arm light guide. The method comprises a 3D printing stage wherein an extrudate comprising a 3D printable material is deposited in a layer-wise manner to provide the 3D item comprising a 3D printed material. In view of optical applications the 3D printable material comprises a light transmissive material. The 3D item comprises one or more layers of the 3D printed material. Further, each of the connected body elements comprises at least two adjacent 3D printed layer parts. Further, the method comprises for each of the body elements printing a single continuous layer part comprising the at least two adjacent 3D printed layer parts, wherein the printing of the single continuous layer part involves printing in a first direction and then turning back and printing back in a second direction opposite to the first direction to provide a first body element U-turn at the first end of the body element. Yet further, the method comprises connecting adjacent body elements by one or more of (i) merging parts of the adjacent body elements (for example by printing close to each other so that they touch each other, especially close to the first end), (ii) 3D printing a connection element connecting the adjacent body elements, and (iii) 3D printing the single continuous layer part comprising the 3D printed layer parts of the adjacent body elements.

Especially, such 3D item may allow a good incoupling of the light in the body elements via the first end(s) (via the U-turn), and outcoupling of the light via the second end(s), with the light propagating through the light transmissive material. As the shape and extend of divergence of the body elements, but also as the number of body elements may be selected, the shape of the beam of light that may escape from the 3D item may be relatively freely be chosen. Amongst others, a bat-wing shaped light distribution may be provided with a light source and embodiments of the 3D printed item described herein. Hence, with the present invention 3D printed optics may be provided. The 3D printed optics can be used to create predefined beam shapes. Therefore, amongst others the invention provides in embodiments a 3D printed item which is (or can be used) a multi-arm type light guide.

Hence, the invention provides a method for producing a 3D item by means of fused deposition modelling. The method comprising a 3D printing stage comprising (layer-wise) depositing an extrudate (comprising 3D printable material), to provide the 3D item comprising 3D printed material. In general, the 3D printed item will be deposited layer by layer. As in the present invention it may not be excluded that a single, relative thick, layer may be used, the invention may also be related to a 3D printed item essentially consisting of a single layer.

Herein, the term “layer” and “single layer” may especially refer to a single level of 3D printed material. For instance, when printing 3D printed material on a building plate with the 3D printed material having a first height, a layer with the first layer height is created, essentially irrespective of the structure of that layer. On such layer, a further layer may be deposited, which has a second layer height, often the same as the first layer height. Hence, in this way, layer by layer may be deposited. Herein, the present invention is especially defined in relation to a single layer, even though the 3D printed item may comprise a plurality of such layers, which may provide the characteristic ribbed structures of the 3D printed item. Hence, the herein defined embodiments may apply to a single layer of a 3D printed item and to a plurality of layers of the 3D printed item, or to a subset of the total number of layers of the 3D printed item.

Hence, herein the 3D item may comprise one or more layers of the 3D printed material, especially a plurality of layers.

As indicated above, the 3D printable material may especially comprises light transmissive material. Examples of such materials are described below.

The transmission or light permeability can be determined by providing light at a specific wavelength with a first intensity to the material and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989). In specific embodiments, a material may be considered transmissive when the transmission of the radiation at a wavelength or in a wavelength range, especially at a wavelength or in a wavelength range of radiation generated by a source of radiation as herein described, through a 1 mm thick layer of the material, especially even through a 5 mm thick layer of the material, under perpendicular irradiation with said radiation is at least about 85%, such as even at least about 90%. Herein, values for transmission especially refer to transmission without taking into account Fresnel losses at interfaces (with e.g. air). Hence, the term “transmission” especially refers to the internal transmission. The internal transmission may e.g. be determined by measuring the transmission of two or more bodies having a different width over which the transmission is measured. Then, based on such measurements the contribution of Fresnel reflection losses and (consequently) the internal transmission can be determined. Hence, especially, the values for transmission indicated herein, disregard Fresnel losses. The light transmissive material for the current application further may especially be a material which is also a substantially light scattering free material.

Especially, the 3D item comprises an articulated body of at least two connected body elements, each having a first end and a second end, wherein the second ends may diverge from each other. When there are more than two body element, a subset of two or more second ends of the total number of second ends may diverge from each other.

Hence, the articulate body may be defined by at least two body elements, which each have a first end and a second end, wherein the first ends are closer to each other than the second end. In this way, the body elements are configured diverging.

In specific embodiments, the body elements may be elongated. Hence, they may have aspect ratios of larger than 1, such as larger than 2, like at least 2.5, such as in the range of 2-100. The aspect ratios may refer to the ratio of the length of the body element and the width of the body element, the ratio of the length of the body element and the height of the body element, and the ratio of the length of the body element and the diameter of the body element. The body elements may be straight or curved, such as e.g. described in WO2017/118565, which is herein incorporated by reference. The body elements may (thus) have axes of elongation. The axes of elongation may be straight or curved, or comprise straight parts and curved parts. In general, the body elements may have a thickness selected from the range of 0.1-5 cm, such as 0.5-5 cm and/or lengths of 0.6-30 cm. The height may be at least the layer height (see elsewhere herein), but as more than one layer may be deposited the height may also be much higher, such as over 10 cm, or even over 50 cm, such as over 100 cm.

As indicated above, the 3D item comprises at least two body elements. The 3D item may also comprise more than two body elements, such as 4-8 body elements. However, more than eight body elements may also be possible, for instance when the 3D item is elongated and/or when the 3D item is curved.

Getting back to the body elements, as especially defined in a single layer, especially each of the connected body elements comprise (at least) two adjacent 3D printed layer parts.

Hence, the body elements may be comprised by printing in one direction and then printing back in the opposite direction. This provides (at least) two adjacent 3D printed layer parts. The term “layer part” is used, the layer parts are parts of the layer. In general, the layer parts have the same height as the layer height, but refer to part of the total length of continuous track of the deposited 3D printed material. In embodiments, it is also possible to make multiple U turns and have more than two adjacent 3D printed layers. For instance, after printing hence and forth, 3D printing is commence around the hence and forth 3D printed layer parts. As indicated above, this may be repeated layer after layer.

The phrase “two adjacent 3D printed layer parts” especially refers to parts that are 3D printed over at least part of their length in physical contact with each other and/or partly merged. They can be seen as layer parts in the plane of the layer that are printed next to each other and form a body part of (at least) two 3D printed layer parts. Especially, over essentially the entire length of the (at least) two adjacent 3D printed layer parts there is physical contact and/or the (at least) two adjacent 3D printed layer parts are (partly) merged. Note that physical contact also takes place when layer-wise deposition layers on top of each other.

When printing in one direction and then turning back and printing back in the opposite direction, a U-turn may be provided.

It appears beneficial when the U-turn is the part of the body element where light source light may enter the body element.

Hence, especially the method may comprise for each of the body elements printing a single continuous layer part comprising the at least two adjacent 3D printed layer parts with a first body element U-turn at the first end.

Especially, at the first end there is a single U-turn defined by two adjacent printed layer parts, or a single U-turn comprising or enclosing parts of a plurality of at least two adjacent printed layer parts, or a U-turn comprising a plurality of U-turns. When the first end is defined by (at least) two U-turns of (at least) two adjacent printed layer parts, light incoupling appears to be less efficient and/or the luminous intensity distribution is less desirable.

A plurality of body elements may form a 3D item when they are associated to each other. Hence, the method may comprise connecting adjacent body elements by one or more of (i) merging parts of the adjacent body elements, (ii) 3D printing a connection element connecting the adjacent body elements, and (iii) 3D printing the single continuous layer part comprising the 3D printed layer parts of the adjacent body elements.

Note that the three options provided here for connecting body elements do not imply that first a first body element is provided, then a second body element is provided, adjacent to the first body element, and then the connection of provided. During 3D printing the first body element, the second body element, and the connection may be provided. This may also imply printing part of the first body element, creating at least part of a (future) connection, printing part of the second body element, creating another part of the (future) connection, and printing another part of the first body element, etc. etc.

Merging parts of the adjacent body elements may be obtained when the adjacent body elements are not printed physically separated but there is some overlap in 3D printed material that belongs to both adjacent body elements, like a kind of conjoined twins. The connection may especially not at the ends, but between the ends. Hence, the method may comprise merging parts of two adjacent body elements at first positions closer to the first ends of the body elements than to the second ends. As indicated above, this may be repeated layer after layer. Merging parts of adjacent body elements may be executed by 3D printing at least part of both adjacent body elements close to each other so that they touch each other. Due to an increased temperature (of the extrudate), merging may take place. Therefore, when body elements do not have contact during printing, in embodiments (special) layer parts can be inserted to connect the columns of body elements with each other during printing.

Alternatively or additionally, a connection between adjacent body elements may be provided by 3D printing a connection element connecting the adjacent body elements. Hence, here the body elements may be distinguishable as separate bodies or body parts, but they are connected via a bridging element or connection element. The connection may especially not at the ends, but between the ends. However, surprisingly it appears in terms of light outcoupling and or beam shape control beneficial when the connection is provided closer to the second ends than to the first end. Hence, the method may comprises 3D printing the connection element connecting the body elements of two adjacent body elements at second positions closer to the second ends of the adjacent body elements than to the first ends. As indicated above, this may be repeated layer after layer.

In an additional or alternative embodiment a single continuous layer part is provided comprising (in the layer) both body elements, or more precisely both two adjacent layers parts of both body elements. Therefore, in embodiments the method may comprise 3D printing the single continuous layer part comprising the 3D printed layer parts of the adjacent body elements. As indicated above, this may be repeated layer after layer.

The different options of connecting may be combined.

An option of connecting may be used in each layer or an option of connecting may be used in fewer layers than the total number of layers. Hence, the body elements are not necessarily connected at (in) every layer. Columns of body elements may be connected at discrete positions along the column, but may also be connected in each layer.

As indicated above, especially a U-turn is provided at the first end. However, also a U-turn may be provided at the second end. Hence, in embodiments the method step of printing the single continuous layer part comprising the at least two adjacent 3D printed layer parts of at least one of the body elements involves printing in a third direction and then turning back and printing back in a fourth direction opposite to the third direction to provide a second body element U-turn at the second end (312) of the body element. Hence, in embodiments at the second end there may (also) be single U-turn defined by two adjacent printed layer parts, or a single U-turn comprising or enclosing parts of a plurality of at least two adjacent printed layer parts, or a U-turn comprising a plurality of U-turns.

In terms of outcoupling of light, it also appears that when the second body element U-turn is not fully curved, but flattened (a bit), light may be better coupled out. Therefore, in embodiments the method may comprise providing the second body element U-turn with a flattened face of which at least part is perpendicular to a plane of printing. Such flattening may—amongst others—be created by control of the printer nozzle. Hence, by choosing the loop or track in which the 3D printable material is printed, the U-turn(s) and flattened U-turn(s) may be created.

As two or more of the at least two body elements may be articulated, with the first ends closer to each other than the second ends, at the first end a cavity may be provided, around which the two or more (first ends of the) body elements may be arranged. Hence, in embodiments the method may comprising 3D printing the at least two connected body elements around a cavity. The cavity may be used to arrange a light source, such as a solid state light source (see also below). As indicated above, this may be repeated layer after layer. Hence, the cavity may be elongated, and in specific embodiments an elongated light source, such as a LED strip, may be provided in such cavity.

Therefore, the 3D item may comprise at least a single layer. That layer may especially comprise (part of) the at least two body elements, more precisely both two adjacent layers parts of both body elements, as well as the optional connection elements.

This layer, or at least the afore-mentioned elements thereof, may be comprised by a single continuous layer (part). Hence, in embodiments the method may comprise printing the one or more layers of 3D item as one or more single continuous layer parts, wherein each of the layer parts are comprised by the one or more single continuous layer parts. Hence, the method may comprise in embodiments spiralized printing. When executing spiralized printing, the layer parts, and the optional connection element, may be printed in a single loop. In principle, the loop may be started at any point. However, in embodiments starting may not be (right) at a first end or (right) at a second end.

Hence, in embodiments the method may comprise layer-wise depositing a plurality of single continuous layer parts (even more especially a plurality of single continuous layers).

In specific embodiments, the layers may have layer heights (H) and layer widths (W) selected from the range of 0.1-5 cm, such as 0.5-5 cm, like 0.5-2.5 cm. As indicated above, this may be repeated layer after layer. Hence, a plurality of 3D printed layers, each having a height selected from this range, may be stacked, and thereby provide the 3D printed item. As will be clear from the above, the 3D printed layer parts may thus also have layer heights (H) and layer widths (W) selected from the range of 0.1-5 cm, such as 0.5-5 cm, like 0.5-2.5 cm.

Hence, in specific embodiments the method may comprise layer-wise depositing a plurality of the layers along a height (or item height (H1)) perpendicular to a plane of printing, to provide an elongated 3D item. As indicated above, the height may be at least the layer height (see elsewhere herein), but as more than one layer may be deposited the height may also be much higher, such as over 10 cm, or even over 50 cm.

As indicated above, the method comprises depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. The 3D printable material is printed as a filament and deposited as such. The 3D printable material may be provided as filament or may be formed into a filament. Hence, whatever starting materials are applied, a filament comprising 3D printable material is provided by the printer head and 3D printed. The term “extrudate” may be used to define the 3D printable material downstream of the printer head, but not yet deposited. The latter is indicated as “3D printed material”. In fact, the extrudate comprises 3D printable material, as the material is not yet deposited. Upon deposition of the 3D printable material or extrudate, the material is thus indicated as 3D printed material. Essentially, the materials are the same material, as the thermoplastic material upstream of the printer head, downstream of the printer head, and when deposited, is essentially the same material.

Herein, the term “3D printable material” may also be indicated as “printable material. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action comprises heating the 3D printable material above the glass transition and if it is a semi-crystalline polymer above the melting temperature. In yet another embodiment, the 3D printable material comprises a (thermoplastic) polymer having a melting point (Tₘ), and the printer head action comprises heating the 3D printable material to be deposited on the receiver item to a temperature of at least the melting point. The glass transition temperature is in general not the same thing as the melting temperature. Melting is a transition which occurs in crystalline polymers. Melting happens when the polymer chains fall out of their crystal structures, and become a disordered liquid. The glass transition is a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

As indicated above, the invention thus provides a method comprising providing a filament of 3D printable material and printing during a printing stage said 3D printable material on a substrate, to provide said 3D item.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc. Optionally, the 3D printable material comprises a 3D printable material selected from the group consisting of Urea formaldehyde, Polyester resin, Epoxy resin, Melamine formaldehyde, thermoplastic elastomer, etc. Optionally, the 3D printable material comprises a 3D printable material selected from the group consisting of a polysulfone. Elastomers, especially thermoplastic elastomers, are especially interesting as they are flexible and may help obtaining relatively more flexible filaments comprising the thermally conductive material. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Printable thermoplastic materials, such as also mentioned in WO2017/040893, may include one or more of polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear polyamides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl)acrylates and poly(C₁₋₆ alkyl)methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments for highly transparent polymer, the 3D printable material (and the 3D printed material) may comprise one or more of polycarbonate (PC), polyethylene naphthalate (PEN), styrene-acrylonitrile resin (SAN), polysulfone (PSU, polytethylene terephthalate (PET) and copolymers of PET, acrylonitrile butadiene styrene (ABS), poly(methyl methacrylate) (PMMA), polystyrene (PS), styrene acrylic copolymers (SMMA), and polyurethane.

The term 3D printable material is further also elucidated below, but especially refers to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture is especially not larger than 60 vol. %, relative to the total volume of the printable material (including the (anisotropically conductive) particles) especially in applications for reducing thermal expansion coefficient. For optical and surface related effect number of particles in the total mixture is equal to or less than 20 vol. %, such as up to 10 vol. %, relative to the total volume of the printable material (including the particles). Hence, herein especially the number of particles in the total mixture is equal to or less than 10 vol. %, relative to the total volume of the printable material (including the particles) or the printed material (including the particles).

Hence, the 3D printable material especially refers to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

The printable material is printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material is deposited, by which the 3D printed item is generated (during the printing stage). The 3D printed item may show a characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc. Post-processing may include smoothening the ribbed structures, which may lead to an essentially smooth surface.

Further, the invention relates to a software product that can be used to execute the method described herein. Therefore, in yet a further aspect the invention also provides a computer program product, when running on a computer which is functionally coupled to or comprised by a fused deposition modeling 3D printer, is capable of bringing about the method as described herein.

The herein described method provides a multi-arm light guide in the form of a 3D printed item. Hence, the invention also provides in a further aspect a multi-arm light guide obtainable with the herein described method.

A multi-arm light guide obtainable with the herein described method is a 3D item comprising 3D printed material, wherein the 3D item comprises one or more layers of 3D printed material, wherein the 3D printed material especially comprises light transmissive material, wherein the 3D item comprises an articulated body of at least two connected body elements, each having a first end and a second end, wherein the second ends diverge from each other, wherein each of the connected body elements comprise at least two adjacent 3D printed layer parts, wherein in specific embodiments (a) the at least two adjacent 3D printed layer parts of each of the body elements are comprised by a single continuous layer part with a first body element U-turn at the first end; and (b) adjacent body elements are connected by one or more of (i) merged parts of the body elements, (ii) a connection element connecting the body elements, and (iii) the single continuous layer part comprising the 3D printed layer parts of the adjacent body elements. Combination of different types of connections may also be applied in a single 3D printed item.

The 3D printed item may comprise a plurality of layers on top of each other, i.e. stacked layers. The thickness and height of the layers may e.g. in embodiments be selected from the range of 0.1-5 cm, such as 0.5-5 cm, such as 0.5-2.5 cm (see also above), with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

At least part of the 3D printed item may include a coating.

Some specific embodiments in relation to the 3D printed item have already been elucidated below when discussing the method. Below, some specific embodiments in relation to the 3D printed item are discussed in more detail.

A (single) continuous layer may comprise one or more single continuous layer parts. For instance, single) continuous layer may comprise a plurality of 3D printed layer parts of a plurality of body elements.

As indicated above, in embodiments the at least two adjacent 3D printed layer parts of each of the body elements are comprised by a single continuous layer part with a second body element U-turn of the at least two adjacent 3D printed layer parts at the second ends.

Further, in specific embodiments the second body element U-turns may have a flattened face perpendicular to an axis of elongation (A1) of the respective body elements. The flattened surface may in embodiments be at least 0.5 cm², such as at least 1 cm², like in the range of 0.5-5 cm².

In yet further specific embodiments, the 3D item may comprise the (afore-mentioned optional) connection element connecting the body elements of two adjacent the body elements at second positions closer to the second ends of the body elements than to the first ends. Hence, the connection element may be configured at second positions closer to the second ends of the body elements than to the first ends.

In general, there may be one or two connection elements (within a layer, between two body elements). However, more than two connection elements may also be possible. The connection elements may have essentially the same dimensions as one or two 3D printed later parts.

In yet further embodiments, the at least two connected body elements may be arranged around a cavity. As indicated above, the cavity may host a (solid state) light source (see also below).

As indicated above, the 3D item may comprise a plurality of (stacked) layers, defining a height of the 3D item. One or more layers of 3D item may be (one or more, respectively) single continuous layer parts.

As earlier indicated, in embodiments the layers may have layer heights (H) and layer widths (W) selected from the range of 0.1-5 cm, such as 0.5-5 cm, like especially 0.5-2.5 cm. As will be clear to a person skilled in the art, the layer width and layer height are not necessarily identical. In general, the layer height will be smaller than the layer width.

The (with the herein described method) obtained 3D printed item may be functional per se. For instance, the 3D printed item may be a lens, a collimator, a reflector, etc. The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light transmissive element, an optical filter, etc. The term optical component may also refer to a light source (like a LED). The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. Alternatively, or additionally, the functional component may comprise a thermal component (e.g. configured to cool or to heat an electrical component). Hence, the functional component may be configured to generate heat or to scavenge heat, etc.

As indicated above, the 3D printed item maybe used for different purposes. Amongst others, the 3D printed item maybe used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the 3D item may be configured as one or more of (i) at least part of lighting device housing, (ii) at least part of a wall of a lighting chamber, and (iii) an optical element. As a relative smooth surface may be provided, the 3D printed item may be used as mirror or lens, etc. In embodiments, the 3D item may be configured as shade. A device or system may comprise a plurality of different 3D printed items, having different functionalities.

However, in a specific aspect, the invention also provides a lighting device comprising the 3D item as defined herein, and a light source configured to generate light source light, wherein the two or more first body element U-turns are configured in a light receiving relationship with the light source. The term “light receiving relationship” especially indicates that the light source and 3D item are configured such, that light source light of the light source will reach the first body element U-turn(s). This may be no solid material between the light source and the first body element U-turns. However, in other embodiments there may be solid material between the light source and the first body element U-turns. In the latter embodiments, this may be 3D printed material. Especially, however, such optional intermediate configured material is also light transmissive, such that light source light reaches first body element U-turns.

As the light transmissive material is transmissive for light, the 3D item may have light guiding or wave guiding properties. Hence, light reaching the first body element U-turns may propagate though the body element and escape therefrom (amongst others) at the second body element U-turn(s). By choosing the shape of the 3D item, a desired light distribution may be achieved.

The term “light source” may refer to a semiconductor light-emitting device, such as a light emitting diode (LEDs), a resonant cavity light emitting diode (RCLED), a vertical cavity laser diode (VCSELs), an edge emitting laser, etc. The term “light source” may also refer to an organic light-emitting diode, such as a passive-matrix (PMOLED) or an active-matrix (AMOLED). In a specific embodiment, the light source comprises a solid state light source (such as a LED or laser diode). In an embodiment, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module. The term “light source” may also relate to a plurality of (essentially identical (or different)) light sources, such as 2-2000 solid state light sources. In embodiments, the light source may comprise one or more micro-optical elements (array of micro lenses) downstream of a single solid state light source, such as a LED, or downstream of a plurality of solid state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

The phrases “different light sources” or “a plurality of different light sources”, and similar phrases, may in embodiments refer to a plurality of solid state light sources selected from at least two different bins. Likewise, the phrases “identical light sources” or “a plurality of same light sources”, and similar phrases, may in embodiments refer to a plurality of solid state light sources selected from the same bin.

The light source(s) may be configured to generate white light or colored light. Hence, especially the light source(s) are configured to generate visible light source light. In embodiments, the optical properties of the light source light may be controlled.

The term “white light” herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL.

The terms “visible”, “visible light” or “visible emission” and similar terms refer to light having one or more wavelengths in the range of about 380-780 nm.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The system, or apparatus, or device may execute an action in a “mode” or “operation mode” or “mode of operation”. Likewise, in a method an action or stage, or step may be executed in a “mode” or “operation mode” or “mode of operation”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In specific embodiments, the light source(s) may at least partially be configured in the afore-mentioned cavity of the 3D printed item. As indicated above, the cavity may essentially be defined by the 3D printed material of the 3D item.

Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material, wherein the fused deposition modeling 3D printer further comprises (c) a control system, wherein the control system is configured to execute the method as defined herein.

The printer nozzle may include a single opening. In other embodiments, the printer nozzle may be of the core-shell type, having two (or more) openings. The term “printer head” may also refer to a plurality of (different) printer heads; hence, the term “printer nozzle” may also refer to a plurality of (different) printer nozzles.

The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, wherein the fused deposition modeling 3D printer further comprises (c) a control system, wherein the control system is configured to execute the method as defined herein.

Especially, the 3D printer comprises a controller (or is functionally coupled to a controller) that is configured to execute in a controlling mode (or “operation mode”) the method as described herein.

The system, or apparatus, or device may execute an action in a “mode” or “operation mode” or “mode of operation”. Likewise, in a method an action or stage, or step may be executed in a “mode” or “operation mode” or “mode of operation”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIGS. 2a-2b schematically depict some aspects;

FIGS. 3a-3d, 4a-4b, 5a-5b, 6a-6b, 7a-7b, and 8a-8c schematically depict various embodiments and variants.

The schematic drawings are not necessarily to scale.

### DETAILED DESCRIPTION OF THE EMBODIMENTS

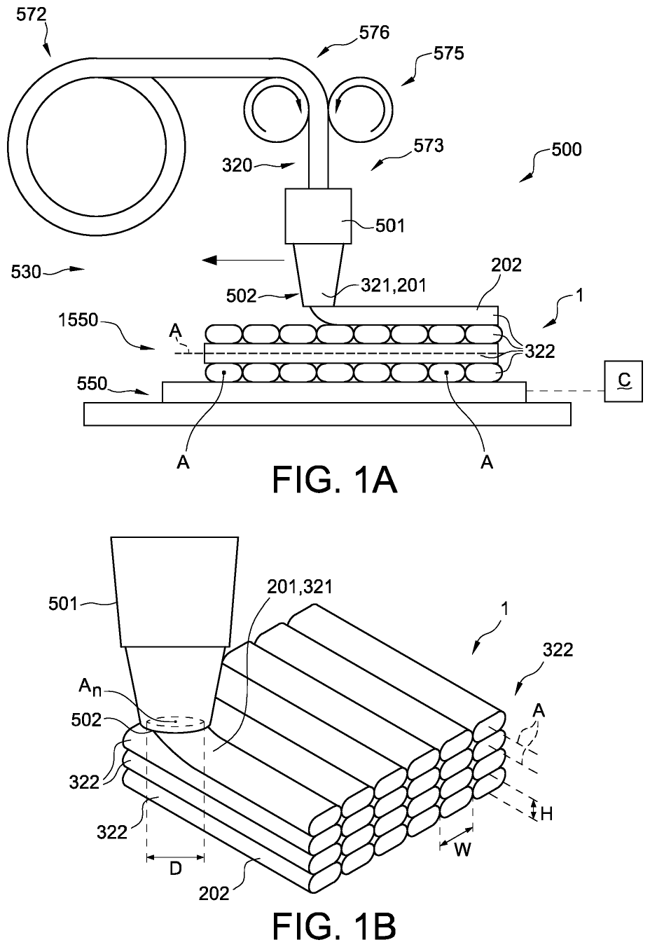

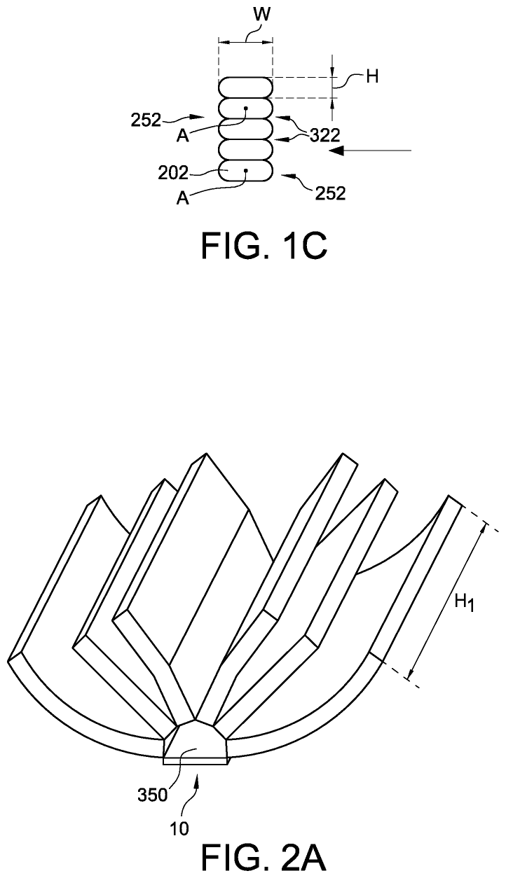

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as a FDM 3D printer head is schematically depicted. Reference 501 indicates the printer head. The 3D printer of the present invention may especially include a plurality of printer heads, though other embodiments are also possible. Reference 502 indicates a printer nozzle. The 3D printer of the present invention may especially include a plurality of printer nozzles, though other embodiments are also possible. Reference 321 indicates a filament of printable 3D printable material (such as indicated above). For the sake of clarity, not all features of the 3D printer have been depicted, only those that are of especial relevance for the present invention (see further also below).

The 3D printer 500 is configured to generate a 3D item 1 by layer-wise depositing on a receiver item 550, which may in embodiments at least temporarily be cooled, a plurality of filaments 321 wherein each filament 310 comprises 3D printable material 201, such as having a melting point Tₘ. The 3D printable material 201 may be deposited on a substrate 1550 (during the printing stage).

The 3D printer 500 is configured to heat the filament material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in a filament 321 downstream of the printer nozzle which becomes a layer 322 on the receiver item or on already deposited printed material. In general, the diameter of the filament 321 downstream of the nozzle is reduced relative to the diameter of the filament 322 upstream of the printer head. Hence, the printer nozzle is sometimes (also) indicated as extruder nozzle. Arranging layer 322 by layer 322 and/or layer 322t on layer 322, a 3D item 1 may be formed. Reference 575 indicates the filament providing device, which here amongst others include the spool or roller and the driver wheels, indicated with reference 576.

Reference A indicates a longitudinal axis or filament axis.

Reference C schematically depicts a control system, such as especially a temperature control system configured to control the temperature of the receiver item 550. The control system C may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material.

Reference D indicates the diameter of the nozzle (through which the 3D printable material 201 is forced).

FIG. 1b schematically depicts in 3D in more detail the printing of the 3D item 1 under construction. Here, in this schematic drawing the ends of the filaments 321 in a single plane are not interconnected, though in reality this may in embodiments be the case. Reference H indicates the height of a layer. Layers are indicated with reference 203. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 321 comprising 3D printable material 201 to the first printer head 501, and optionally (c) a receiver item 550. In FIGS. 1a-1b, the first or second printable material or the first or second printed material are indicated with the general indications printable material 201 and printed material 202. Directly downstream of the nozzle 502, the filament 321 with 3D printable material becomes, when deposited, layer 322 with 3D printed material 202.

FIG. 1c schematically depicts a stack of 3D printed layers 322, each having a layer height H and a layer width W. Note that in embodiments the layer width and/or layer height may differ for two or more layers 322. Reference 252 in FIG. 1c indicates the item surface of the 3D item (schematically depicted in FIG. 1c).

Referring to FIGS. 1a-1c, the filament of 3D printable material that is deposited leads to a layer having a height H (and width W). Depositing layer 322 after layer 322, the 3D item 1 is generated.

As indicated above, amongst others herein various printing strategies for printing a wave guided beam shaping optics for obtaining the desired optical effect are described. Best results were obtained when the wave guide plate entrance had a single curve and exit surface was as flat as possible. The presence of the ribbed structure, due to the availability of stacked layers, also helped spreading the beam removing the spotty appearance. In a desirable configuration the wave guide elements get connected to each other forming a self-supporting luminaire where the surfaces of the waveguide are protected against dust and other dirt. Furthermore, it makes it possible to combine different wave plate configurations in such a luminaire in order to produce different light distributions from different parts of the luminaire.

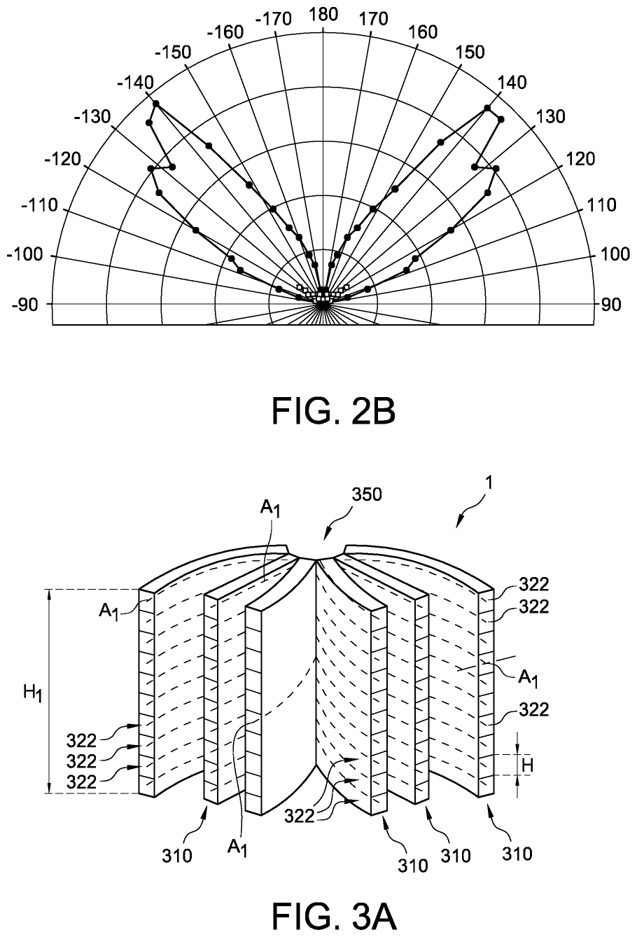

Amongst others, we suggest the use of multi arm distributed wave guides to obtain any desired beam shape in the far field. Multiple wave guides can be placed above a light source for coupling light into these light guides. The orientation of the end of the wave guides can then be aligned in a desired manner to obtain the desired light distribution. FIG. 2a schematically depicts a possible wave guide design. The theoretical beam shape which could be obtained from such a wave guide is shown in FIG. 2b. FIG. 2b shows that a so-called bat wing type of light distribution can be obtained from such a wave guide arrangement placed above the LED strip. A LED strip is an example of a light source 10. The light source 10 may at least partly be configured in a cavity 350.

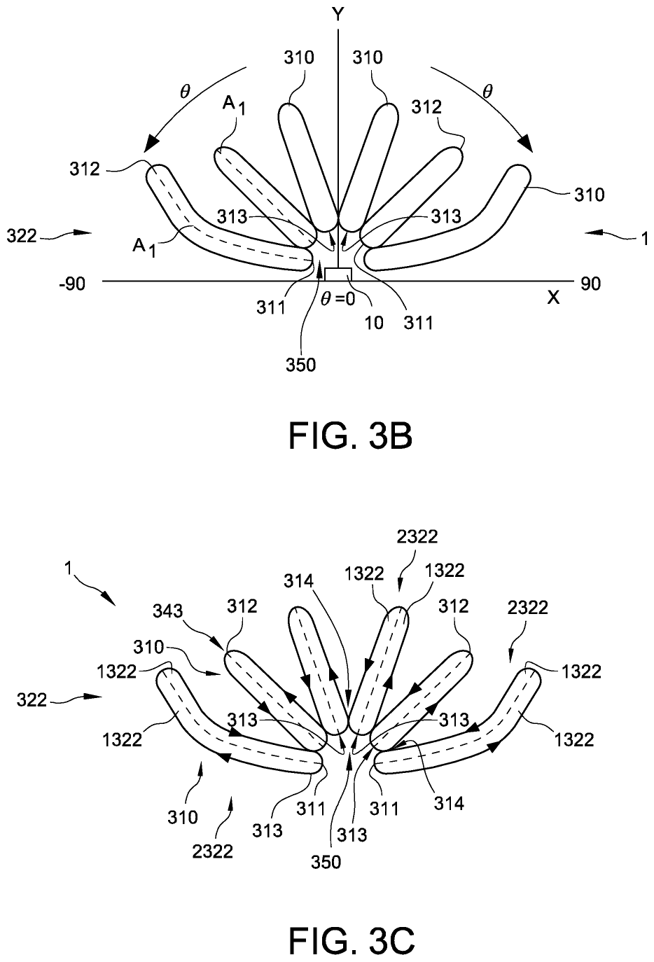

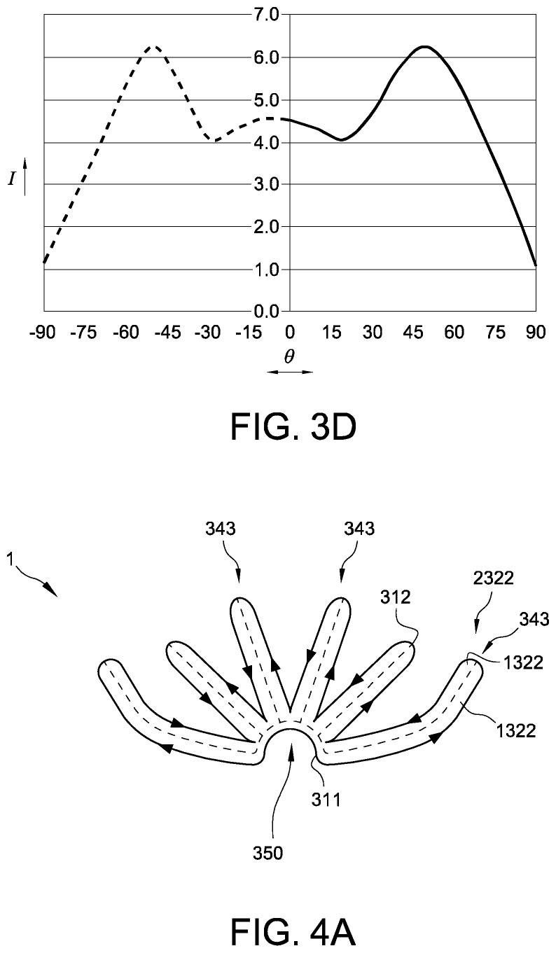

It may be desirable to produce such a wave guide arrangement using FDM printing. FIG. 3a schematically shows the orientation of the object with respect to the built plate. This orientation is especially chosen so that the layers are produced in the direction of the waveguide defining the light propagation. Hence, the body elements, indicated with references 310, of the articulate body may be printed layer by layer with an axis of elongation A1 of the body elements parallel to the built plate and the printing direction/printing plane.

When a nozzle with a size smaller than the size of the details are used flat edges and sharp corners. However, printing with a small nozzle results in printing times which are commercially not interesting. For this reason, amongst others a spiralized printing strategy is herein suggested, where the printer follows continuously a path. Especially, when a relatively large nozzle (1.8 mm diameter) leading to layer width W which is about the same size as the nozzle diameter is used, sharp and straight side edges present in the original design may become curved. The layer height H is indicated in FIG. 3a.

As the method may comprise layer-wise depositing a plurality of the layers 322 along a height H1 (item height H1) perpendicular to a plane of printing, to provide an elongated 3D item 1, in FIG. 3a such item with height H1 is depicted. The layers 322 may provide a ribbed structure (which is in this schematic drawing not indicated, but the lines between layers at the side face may e.g. be interpreted as (small) indentations between ribs.

FIG. 3b schematically depicts a geometry of the 3D item. Reference 311 indicates a first end of the body elements 310 and reference 312 indicates a second end of the body elements 310. The latter may also be indicated as a terminal end of the body element 310.

Below various printing strategies for printing such a wave guided beam shaping optics (for obtaining the desired optical effect) are described and compared. Amongst others such as continues in plane printing followed by a vertical move print the subsequent layer, so-called spiralize printing was applied, where the nozzle moves in the x-y plane and after each movement the stage (or built plate) moves downwards in z direction. For measuring light distribution from the waveguide a LED placed underneath the waveguide plate and the light intensity was measured as a function of angle as indicated in FIG. 3b

In a first design 1, separate wave guide elements or body elements 310 are touching each other, see FIG. 3c. In FIG. 3c schematically the movement of the printer head as it moves to move to print one wave guide element is shown and the thus obtained item 1 is (also) shown.

FIG. 3c also shows how in practice a method for producing a 3D item 1 by means of fused deposition modelling, the method comprising a 3D printing stage comprising depositing an extrudate 321 comprising 3D printable material 201, to provide the 3D item 1 comprising 3D printed material 202 may be executed. As indicated above, the 3D printable material 201 comprises light transmissive material. The 3D item 1 comprises one or more layers 322; here, only one layer is depicted. Perpendicular to the plane of drawing, further layers 322 may be provided of the 3D printed material 202. As indicated above, consequently the 3D printed material 202 comprises light transmissive material

The 3D item 1 comprises an articulated body of at least two connected body elements 310, each having a first end 311 and a second end 312. The second ends 312 diverge from each other. Each of the connected body elements 310 comprises at least two adjacent 3D printed layer parts 1322.

Especially, the method comprises for each of the body elements 310 printing a single continuous layer part 2322 comprising the at least two adjacent 3D printed layer parts 1322 with a first body element U-turn 313 at the first end 311.

Further, the method may comprise connecting adjacent body elements 310 by one or more of (i) merging parts of the adjacent body elements 310, (ii) 3D printing a connection element 320 connecting the adjacent body elements 310, and (iii) 3D printing the single continuous layer part 2322 comprising the 3D printed layer parts 1322 of the adjacent body elements 310. Here, adjacent body elements 310 are merged together, at a position closer to the first end than to the second end. Several layer heights for the 3D printed layers 322 were chosen, amongst others 0.4 mm and 0.6 mm. Reference 314 indicates a connection (especially by merging).

FIG. 3c also shows that the (two) adjacent 3D printed layer parts especially refers to parts that are 3D printed over at least part of their length in physical contact with each other and/or partly merged.

FIGS. 3b and 3c also show that the axes of elongation may be straight or curved, or comprise straight parts and curved parts.

For the former, the luminous intensity distribution is shown in FIG. 3d. For the latter the intensity distribution is essentially the same. FIG. 3d shows the light intensity as a function of angle theta the version with a layer height of 0.4 mm. Hence, a batwing pattern can be obtained.

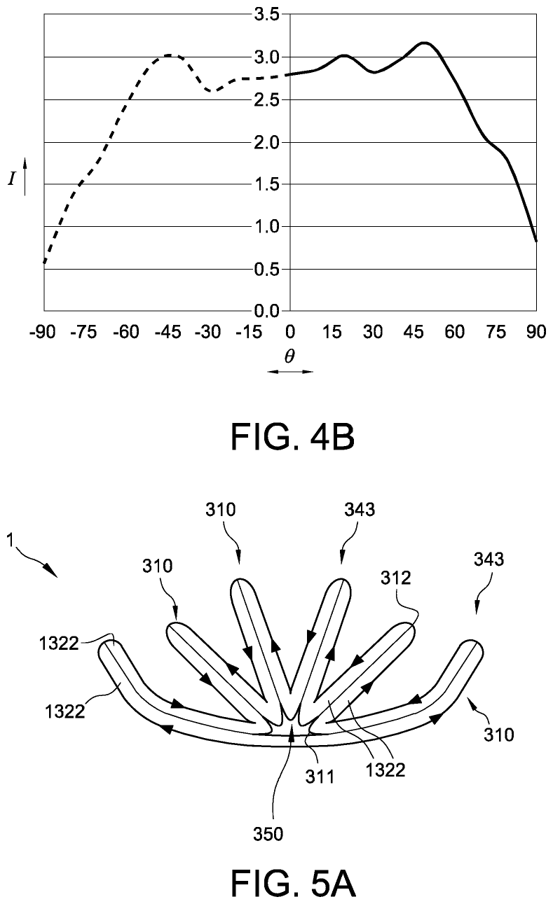

In another design, see FIG. 4a, a connected wave guide printing in a true spiralized way where the printer head moves in one closed loop. Here the entrance surface (at the first end 311) is smooth and continuous for all waveguide segments. Note that the body element 310 does not have a U-turn at the first ends of the arms. FIG. 4b shows the luminous intensity as a function of angle theta. In FIG. 4b it can be seen that the batwing pattern is essentially not available. This may not be desired for specific applications.

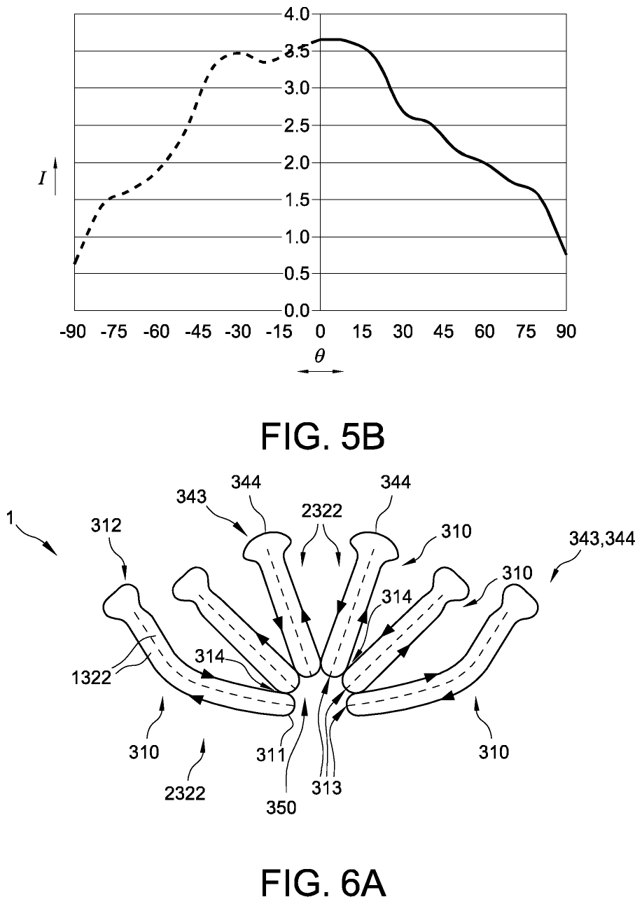

In yet another design, see FIG. 5a, a connected wave guide printing in a true spiralized way is schematically depicted, where the printer head moves in one closed loop. In this figure it can be seen that the entrance of the waveguide is split. Hence, also here no U-turn is available at the first end. FIG. 5b shows the luminous intensity as a function of angle theta. In FIG. 5b it can be seen that also here the batwing pattern is absent.

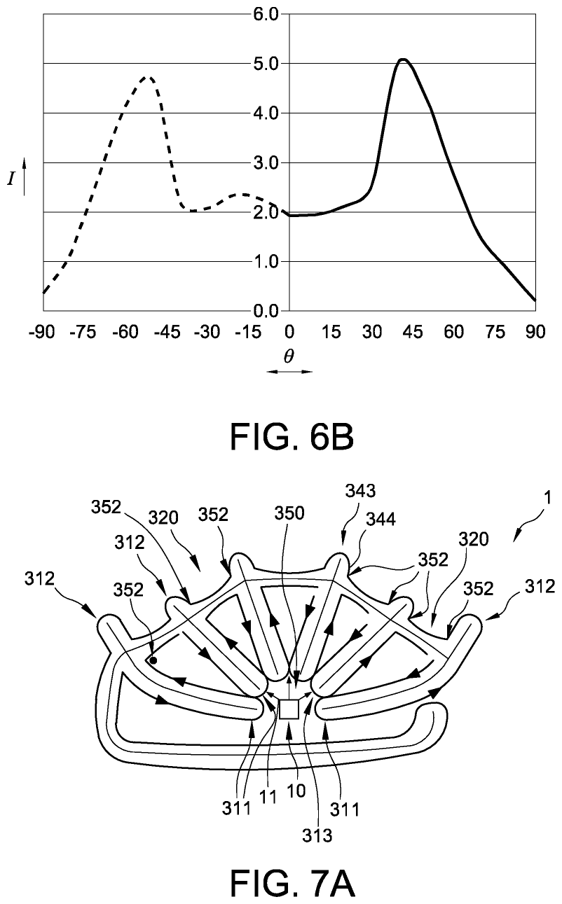

In yet a further design (modified design 1; see also FIG. 3c), the exit surfaces were flat as shown; see FIG. 6a.

FIG. 6a (but also FIGS. 3c, 4a, and 5a) shows an embodiment with at the second end 312 a second body element U-turn 343. FIG. 6a especially shows an embodiment comprising the second body element U-turn 343 which comprises a flattened face 344 of which at least part is perpendicular to a plane of printing. FIG. 6b shows the luminous intensity as function of the angle theta. In FIG. 6b it can be seen that the batwing pattern is more prominent than the one obtained for design of FIG. 3c.

Referring to FIGS. 5a and 6a/7a, especially, at the first end there is a single U-turn 313 defined by two adjacent printed layer parts (see FIG. 6a/7a, or a single U-turn comprising or enclosing parts of a plurality of at least two adjacent printed layer parts. When the first end is defined by (at least) two U-turns of (at least) two adjacent printed layer parts (see FIG. 5a), light incoupling appears to be less efficient and/or the luminous intensity distribution is less desirable.

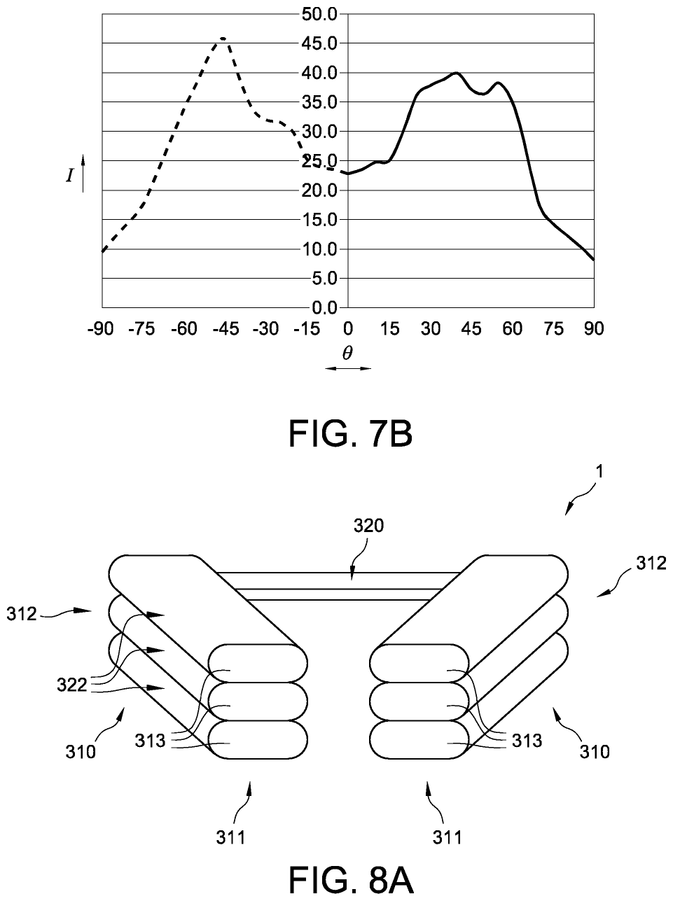

In order to make a self-supporting luminaire where the surfaces of the waveguide is protected against dust and other dirt, wave guide is elements were connected to each other and platform was created to place a led strip and align the LEDs with respect to the wave guides. In FIG. 7a a connected wave guide printing in a true spiralized way is shown, where the printer head moves in one closed loop. The luminous intensity as function of theta is shown in FIG. 7b. It can be seen that such a wave guide luminaire shows a batwing light distribution.

FIG. 7a also schematically shows an embodiment, or the result thereof, wherein the method comprising 3D printing a connection element 320 connecting the body elements 310 of two adjacent body elements 310 at second positions 352 closer to the second ends 312 of the adjacent body elements 310 than to the first ends 311. FIG. 7a also schematically shows an embodiment, or the result thereof, of a method comprising 3D printing the at least two connected body elements 310 around a cavity 350.

FIG. 7a also schematically depicts an embodiment of a lighting device 1000 comprising the 3D item 1 and the light source 10. The light source 10 is configured to generate light source light 11. Further, especially the two or more first body element U-turns 313 are configured in a light receiving relationship with the light source 10. Further, an embodiment is schematically depicted wherein the light source 10 is at least partially configured in the cavity 350 of the 3D printed item 1.

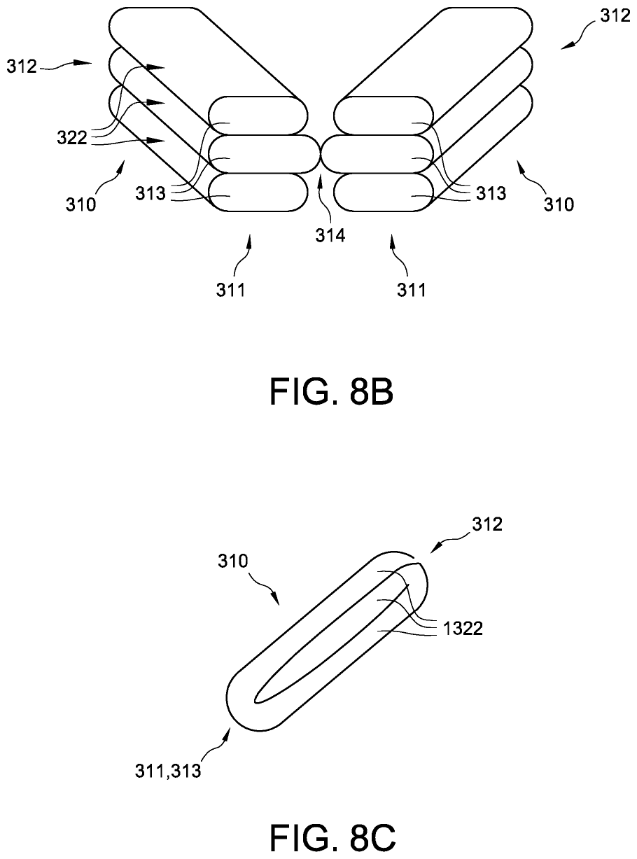

FIG. 8a schematically depicts an embodiment with two body elements 310, each comprising 3D printed layer parts 1322 in three layers 322 (though they do not necessarily comprise the same number of layers 322), wherein connection element 320 connecting the adjacent body elements 310 is only available between adjacent 3D printed layer parts in one or two of the three layers 322, whereas the adjacent 3D printed layer parts within the two ore one layers 322 are not connected.

FIG. 8b schematically depicts an embodiment with two body elements 310, each comprising 3D printed layer parts 1322 in three layers 322 (though they do not necessarily comprise the same number of layers 322), wherein a connection 314 by merging is provided due to a merging of two adjacent 3D printed layer parts in the middle layer 322, whereas the adjacent 3D printed layer parts within the lowest and the highest layer 322 are not connected.

Hence, the fact that adjacent body elements 310, each comprising a stack of 3D printed layer parts within different layers on top of each other, does not necessarily imply that within each level or layer 322 the body elements 310 are connected by merging or a connection element (or are comprised in each layer by a single continues layer part).

FIG. 8c schematically depicts that a body element 310 (within a single layer) may comprise more than two adjacent 3D printed layer parts, e.g. by printing hence and forth and around the hence and forth 3D printed two adjacent 3D printed layer parts 1322. Hence, the U-curve 313 at the first end may be provided by at least three layer parts 1322.

FIG. 8c also shows that the at least two adjacent 3D printed layer parts especially refers to parts that are 3D printed over at least part of their length in physical contact with each other and/or partly merged.

The embodiment of FIG. 8c also shows that when the body element 310 comprises more than two adjacent 3D printed layer parts 1322, a U-turn 313 comprising a plurality of U-turns may be provided; this may especially be the case when the body element 310 comprises at least four, or especially at least five adjacent 3D printed layer parts 1322.

It is also possible to combine wave guide configurations in a single luminaire in order to produce different light distributions from different parts. Therefore it is possible to have different arm lengths and/or orientations along the print.

The term “substantially” herein, such as “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention also provides a control system that may control the apparatus or device or system, or that may execute the herein described method or process. Yet further, the invention also provides a computer program product, when running on a computer which is functionally coupled to or comprised by the apparatus or device or system, controls one or more controllable elements of such apparatus or device or system.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method for manufacturing a 3D item by means of fused deposition modelling,
wherein the 3D item is a multi-arm light guide having an articulated body of at least two connected body elements, wherein each body element is an arm of the multi-arm light guide, wherein each body element has a first end and a second end, wherein the first ends of the connected body elements are for incoupling of light in the multi-arm light guide, wherein the second ends of the connected body elements diverge from each other and are for outcoupling of light from the multi-arm light guide,
wherein the method comprises a 3D printing stage wherein an extrudate comprising a 3D printable material is deposited in a layer-wise manner to provide the 3D item comprising a 3D printed material (202);
wherein the 3D printable material comprises a light transmissive material;
wherein the 3D item comprises one or more layers of the 3D printed material,
wherein each of the connected body elements comprises at least two adjacent 3D printed layer parts;
wherein the method comprises:
for each of the body elements printing a single continuous layer part comprising the at least two adjacent 3D printed layer parts, wherein the printing of the single continuous layer part involves printing in a first direction and then turning back and printing back in a second direction opposite to the first direction to provide a U-turn at the first end of the body element; and
connecting adjacent body elements by one or more of (i) merging parts of the adjacent body elements, (ii) 3D printing a connection element connecting the adjacent body elements, and (iii) 3D printing the single continuous layer part comprising the 3D printed layer parts of the adjacent body elements.

2. The method according to claim 1, wherein the printing of the single continuous layer part involves printing in a third direction and then turning back and printing back in a fourth direction opposite to the third direction to provide a U-turn at the second end of the body element.

3. The method according to claim 2, comprising providing the U-turn at the second end with a flattened face of which at least part is perpendicular to a plane of printing.

4. The method according to claim 1, wherein the connecting of adjacent body elements is done by merging parts of two adjacent body elements at first positions closer to the first ends of the body elements than to the second ends.

5. The method according to claim 1, wherein the connecting of adjacent body elements is done by 3D printing the connection element connecting the body elements of two adjacent body elements at second positions closer to the second ends of the adjacent body elements than to the first ends.

6. The method according to claim 1, comprising 3D printing the at least two connected body elements around a cavity.

7. The method according to claim 1, comprising printing the one or more layers of 3D item as one or more single continuous layer parts, wherein each of the layer parts are comprised by the one or more single continuous layer parts, wherein the layers have layer heights and layer widths selected from the range of 0.5-5 cm.

8. The method according to claim 1, comprising layer-wise depositing a plurality of the layers along a height perpendicular to a plane of printing, to provide an elongated 3D item.

9. The method according to claim 1, wherein the 3D printable material and the 3D printed material comprise one or more of polycarbonate, polyethylene naphthalate, styrene-acrylonitrile resin, polysulfone, polytethylene terephthalate and its copolymers, acrylonitrile butadiene styrene, poly(methyl methacrylate), polystyrene, styrene acrylic copolymers, and polyurethane.

10. A multi-arm light guide having an articulated body of at least two connected body elements, wherein each body element is an arm of the multi-arm light guide, wherein each body element has a first end and a second end, wherein the first end is for incoupling of light in the multi-arm light guide, wherein the second ends of the connected body elements diverge from each other and are for outcoupling of light from the multi-arm light guide, wherein the multi-arm light guide is a 3D item comprising 3D printed material, and wherein the 3D item is obtainable by the method according to claim 1.

11. The multi-arm light guide according to claim 10, wherein the at least two adjacent 3D printed layer parts of each of the body elements are comprised by a single continuous layer part with a U-turn at the second ends of the at least two adjacent 3D printed layer parts, wherein the U-turns at the second ends have a flattened face perpendicular to an axis of elongation of the respective body elements.

12. The multi-arm light guide according to claim 10, comprising the connection element connecting the body elements of two adjacent the body elements at second positions closer to the second ends of the body elements than to the first ends, wherein the at least two connected body elements are arranged around a cavity, and wherein the one or more layers of 3D item are one or more single continuous layer parts, wherein the layers have layer heights and layer widths selected from the range of 0.5-5 cm.

13. A lighting device comprising the multi-arm light guide according to claim 10, and a light source configured to generate light source light, wherein the two or more U-turns at the first end are configured in a light receiving relationship with the light source so that light source light can be coupled into the multi-arm light guide via the two or more U-turns at the first end.

14. The lighting device according to claim 13, wherein the light source is at least partially configured in the cavity of the multi-arm light guide.

15. A software product when running on a computer which is functionally coupled to or comprised by a fused deposition modeling 3D printer is capable of bringing about the method as described in claim 1.
